(19) United States
(12) Patent Application Publication
(10) Pub. No.: US 2006/0233510 A1
(43) Pub. Date: Oct. 19, 2006

(54) OPTICAL FIBER ARRAY

(75) Inventors: Toshiki Kumagai, Nagano (JP); Osamu Suzuki, Niigata-shi (JP); Junichi Kaneko, Niigata-shi (JP); Yukinari Abe, Niigata-shi (JP); Kazuo Muramatsu, Niigata-shi (JP)

Correspondence Address: DARBY & DARBY P.C., P. O. BOX 5257, NEW YORK, NY, 10150-5257, US

(73) Assignees: Hatakensaku Co., Ltd., Nagano (JP); Namics Co., Niigata-shi (JP)

(21) Appl. No.: 11/422,544

(22) Filed: Jun. 6, 2006

Related U.S. Application Data
(62) Division of application No. 10/480,856, filed on Jan. 27, 2004.

(51) Int. Cl. G02B 6/00

(52) U.S. Cl. 385/137

(57) ABSTRACT

In an optical fiber array (1) which has a V-groove substrate (2) formed in its surface (2a) with V-grooves (3) for arranging optical fibers, a plurality of optical fiber cores (61) fixedly bonded in each individual V-groove (3) of the V-groove substrate (2), and a pressure plate (4) fixedly bonded to surfaces of the optical fiber cores (61), an adhesive comprising a resin composition (component A) having an OH group after curing and a filler (component B) is used to fixedly bond the V-groove substrate (2), the optical fiber cores (61), and the pressure plate (4). This adhesive has a glass transition temperature that is somewhat lower than the ambient test temperature and possesses somewhat higher elasticity. Therefore, large internal stress does not occur in the adhesive even under conditions of high temperature and high humidity. Consequently, no peeling occurs as a result of moisture penetration since gaps cannot form between the pressure plate (4) and the adhesive.

### TECHNICAL FIELD

The present invention relates to an optical fiber array used for coupling a plurality of optical fibers with light waveguide channels or other components of a light waveguide element in optical communication or the like. In particular, the invention relates to an adhesive for fixing a V-groove substrate, optical fiber cores, and a pressure plate in an optical fiber array.

### BACKGROUND ART

An optical fiber array featuring a V-groove substrate is known as an optical fiber fixing structure in which a plurality of optical fibers are arranged at a constant pitch. As shown in FIG. 2, an optical fiber array 1 has a V-groove substrate 2 in which V-grooves 3 for arranging optical fibers are formed in a surface 2a, a plurality of optical fiber cores 61 that are fixedly bonded in the individual V-grooves 3 of the V-groove substrate 2, and a pressure plate 4 made of a glass substrate fixedly bonded to surfaces of the optical fiber cores 61. The optical fiber cores 61 are brought out of tips of the optical fibers in a state in which a coating is removed.

In this state, each optical fiber core 61 is in contact with an inside of a bonding surface 4a of a cover glass 4 and a pair of left and right slanted surfaces 31 and 32 defining the V-grooves 3, and their arrangement positions are defined by these surfaces. The optical fiber cores 61 are fixedly bonded in the V-grooves 3 by an adhesive 8 filled in the V-grooves 3, and the pressure plate 4 is fixedly bonded to the optical fiber cores 61 and the V-groove substrate 2 by an adhesive 7.

For example, a sealing resin composition comprising an oxetane compound alone as a resin component, such as is disclosed in JP-A 11-17074, is conventionally used as the adhesives 7 and 8 to perform such fixed bonding.

The optical fiber array 1 thus structured requires environmental resistance such that, for example, even if left for 20 hours in an atmosphere saturated with water vapor at a temperature of 121° C. and a pressure of 2 atm, the pressure plate 4 does not peel off.

However, when the resin composition comprising only the above-mentioned oxetane compound as the resin component is used as the adhesives 7 and 8, problems result in that adhesion after curing is poor and adequate environmental resistance cannot be ensured.

As shown in FIG. 4(B), attempts have been made in conventional practice to improve environmental resistance by raising a glass transition temperature Tg of the adhesives 7 and 8 above an ambient test temperature, but sufficient environmental resistance cannot be ensured by such efforts.

Therefore, an object of the present invention is to provide an optical fiber array wherein the adhesives are improved and peeling between the V-groove substrate and the cover glass can be reliably prevented.

### DISCLOSURE OF THE INVENTION

In order to solve the above-mentioned problems, according to the present invention, an optical fiber array having a V-groove substrate formed in its surface with V-grooves for arranging optical fibers, optical fiber cores fixedly bonded in the V-grooves of the V-groove substrate, and a pressure plate fixedly bonded to surfaces of the optical fiber cores; characterized in that an adhesive comprising at least a resin composition (component A) having an OH group after curing and a filler (component B) is used to fixedly bond the V-groove substrate, the optical fiber cores, and the pressure plate.

In the present invention, the glass transition temperature is somewhat lower than the ambient test temperature, and elasticity is somewhat higher because the adhesive comprising a resin composition (component A) having the OH group after curing and the filler (component B) is used to fixedly bond the V-groove substrate, the optical fiber cores, and the pressure plate. Therefore, large internal stress does not occur in the adhesive even under conditions of high temperature. Consequently, when the optical fiber array is subject to conditions of high temperature and high humidity, no peeling occurs as a result of moisture penetration since gaps cannot form between the pressure plate and the adhesive.

Specifically, when the optical fiber array is subject to conditions of high temperature and high humidity, the pressure plate is forced to slide and small areas of peeling are formed between the pressure plate and the adhesive if there is a large difference in amounts of thermal expansion between the pressure plate and the adhesive on upper sides of the fiber cores. Moisture enters these areas of peeling, which expand and contract repeatedly, causing the pressure plate to peel off, but in the present invention, gaps do not form between the pressure plate and the adhesive because the adhesive conforms to the movement of the pressure plate.

When the optical fiber array is subject to conditions of high temperature and high humidity, an upward force acts on the optical fiber cores, the pressure plate is pressed upward by the optical fiber cores, and small areas of peeling form between the pressure plate and the adhesive on both sides of the optical fiber cores if there is a difference in amounts of thermal expansion between the adhesives on upper and lower sides of the fiber cores. Moisture enters these areas of peeling, which expand and contract repeatedly, causing the pressure plate to peel off, but in the present invention, the force with which the adhesive acts to press upward the optical fiber cores is extremely small. Therefore, gaps do not form between the pressure plate and the adhesive because the pressure plate is not pressed upward by the optical fiber cores.

In the present invention, the compounding amount of component (B) is preferably 5% by weight to 50% by weight of the entire adhesive.

In the present invention, the adhesive comprises, for example, a resin composition (component C) having an OH group at least after curing as component (A) regardless of whether or not the OH is present during a compounding stage.

In the present invention, it is also possible to use an adhesive comprising a resin composition (component D) that has an OH group during the component compounding stage as component (A) in an amount of 8% by weight or greater of the entire adhesive. In this case, the compounding amount of component (D) is preferably 25% by weight or greater of the entire adhesive.

In the present invention, it is further possible to use an adhesive that comprises both the resin composition (component C) having the OH group at least after curing and the resin composition (component D) having the OH group during the component compounding stage as component (A), and that also comprises component (D) in an amount of 8% by weight or greater of the entire adhesive. In this case, the compounding amount of component (D) is preferably 25% by weight or greater of the adhesive.

In the present invention, component (C) is an epoxy resin, for example.

In the present invention, component (D) is a solid epoxy resin, an oxetane resin, polybutadiene rubber, a polyester resin, or the like.

In the present invention, the adhesive comprises at least one of the following as component (B): a metal oxide (component E) with a mean grain size in a range of 1 nm to 800 nm, and preferably in a range of 1 nm to 400 nm, and resin beads (component F). Here, component (E) may, for example, be silicon oxide, aluminum oxide, titanium oxide, zinc oxide, or the like.

### BRIEF DESCRIPTION OF THE DRAWINGS

FIG. 1 is a longitudinal sectional view of the optical fiber array cut along the optical fiber cores;

FIG. 2 is a longitudinal sectional view of the optical fiber array cut in a direction perpendicular to the optical fiber cores;

FIG. 3 is a longitudinal sectional view of another optical fiber array cut in a direction perpendicular to the optical fiber cores; and

FIGS. 4(A) and (B) are explanatory diagrams showing the characteristics of the adhesive used in the optical fiber array of the present invention, and an adhesive used in a conventional optical fiber array, respectively.

### DESCRIPTION OF SYMBOLS

1: optical fiber array
2: V-groove substrate
3: V-grooves
4: pressure plate
6: optical fibers
61: optical fiber cores
7, 8: adhesives

### BEST MODE FOR CARRYING OUT THE INVENTION

An optical fiber array according to the present invention will be described with reference to the drawings.

(Structure of Optical Fiber Array)

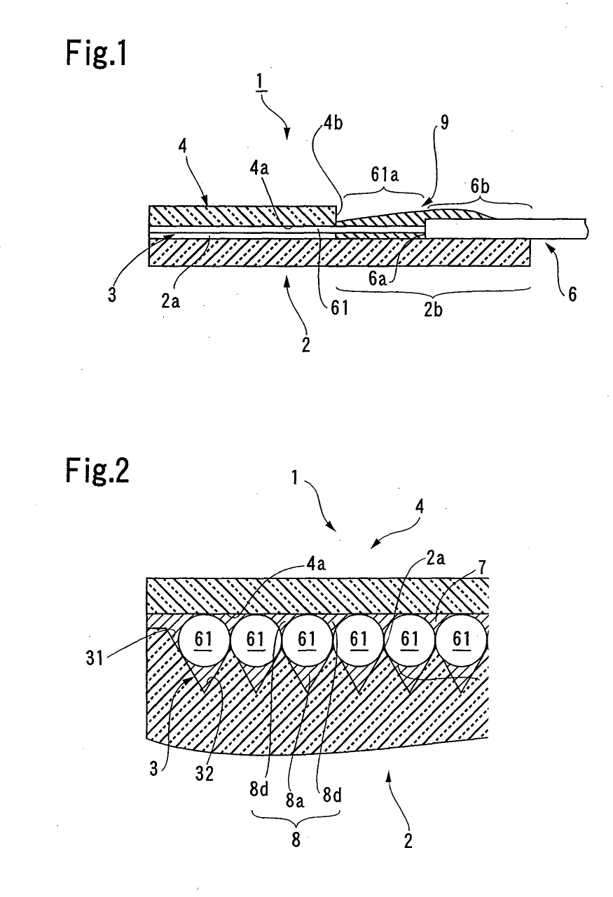

As shown in FIGS. 1 and 2, an optical fiber array 1 has a V-groove substrate 2 formed in its surface 2a with V-grooves 3 for arranging optical fibers, a plurality of optical fiber cores 61 fixedly bonded in the respective V-grooves 3 of the V-groove substrate 2, and a pressure plate 4 made of a glass substrate fixedly bonded to surfaces of the optical fiber cores 61; and the optical fiber cores 61 are accommodated in the V-grooves 3 in a state in which a coating is removed from tips 6a of optical fibers 6. The optical fiber cores 61 have circular cross sections configured from a core and a cladding.

As can be seen from FIG. 2, the optical fiber cores 61 are in contact with an inside of a bonding surface 4a of a cover glass 4 and a pair of left and right slanted surfaces 31 and 32 defining the V-grooves 3, and arrangement positions are defined by these surfaces. Consequently, the size of the V-grooves 3 is set such that the optical fiber cores 61 protrude from surfaces of the V-grooves 3, namely, from the surface 2a of the V-groove substrate 2.

The pressure plate 4 is fixedly bonded to the surface 2a of the V-groove substrate 2 and to each optical fiber core 61 by an adhesive 7.

The optical fiber cores 61 accommodated in the V-grooves 3 are fixedly bonded in the V-grooves 3 by an adhesive 8 filled in the V-grooves 3. The adhesive 8 in the V-grooves 3 comprises bottom adhesive portions 8a surrounded by the pair of left and right slanted surfaces 31 and 32 and the external peripheral surface portions on an underside of the optical fiber cores 61, and left and right upper adhesive portions 8d continued to the adhesive 7 over the optical fiber cores 61.

Different types of adhesives 7 and 8 may be used to perform such fixed bonding, and the same types may also be used. When the same types of adhesives 7 and 8 are used, the fixed bonding of the optical fiber cores 61 and the fixed bonding of the pressure plate 4 may be performed as individual separate steps, or may be performed simultaneously.

Again in FIG. 1, a rear end portion of the V-groove substrate 2 extends farther rearward from a rear end surface 4b of the cover glass 4, and tip portions 6b of the optical fibers 6 rest on a surface of this extended portion 2b. Also located here are exposed portions 61a of the optical fiber cores 61 accommodated in the V-grooves 3 brought out from the tip portions 6a of the optical fibers 6. These tip portions 6b and exposed portions 61a are covered with an adhesive coating film 9. In the present example, the adhesive coating film 9 is formed extending from the cover glass rear end surface 4b to the optical fiber tip portions 6b. Coating thickness at a location of the cover glass rear end surface 4b is roughly half of the thickness of the cover glass 4. Namely, the thickness is roughly half dimensions in a thickness direction of the rear end surface 4b.

(Another Structure of Optical Fiber Array)

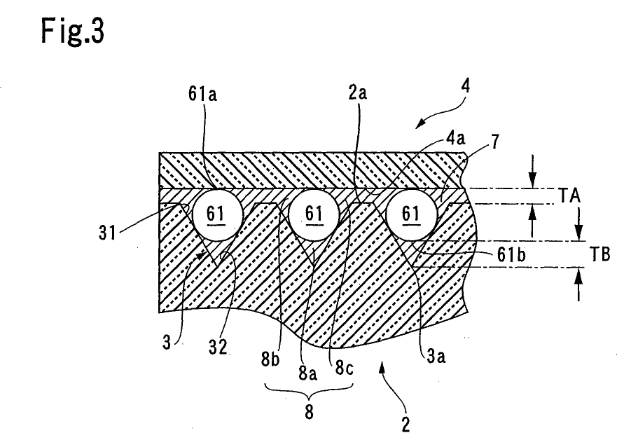

The optical fiber array 1 may also be structured as is shown in FIG. 3.

Also in the optical fiber array 1 shown herein, each optical fiber core 61 is in contact with the inside of the bonding surface 4a of the cover glass 4 and the pair of left and right slanted surfaces 31 and 32 that define V-grooves 3, and the arrangement positions are defined by these surfaces, similar to that shown in FIG. 2.

Also in the optical fiber array 1 shown herein, the pressure plate 4 is fixedly bonded to the surface 2a of the V-groove substrate 2 and to each optical fiber core 61 by the adhesive 7.

The optical fiber cores 61 accommodated in the V-grooves 3 are fixedly bonded to the insides of the V-grooves by the adhesive 8 filled in the V-grooves 3. The adhesive 8 in the V-grooves 3 comprises bottom adhesive portions 8a surrounded by the pair of left and right slanted surfaces 31 and 32 and the external peripheral surface portions on the underside the optical fiber cores 61, and left and right upper adhesive portions 8b and 8c continued to the adhesive 7 and disposed over the optical fiber cores 61.

Different types of adhesives 7 and 8 may be used to perform such fixed bonding, and the same types may also be used. When the same types of adhesives 7 and 8 are used, the fixed bonding of the optical fiber cores 61 and the fixed bonding of the pressure plate 4 may be performed as individual separate steps, or may be performed simultaneously.

Dimensions of the V-grooves 3 are set such that external peripheral surface upper ends 61a of the optical fiber cores 61 protrude from the surface 2a of the V-groove substrate 2 by the amount shown below. Namely, a ratio of extension T_{A} in the present example to distance T_{B} from bottoms 3a of the V-grooves to external peripheral surface lower ends 61b of the optical fiber cores 61 (=T_{A}/T_{B}) is set to a value within a range of about 0.5 to about 0.8.

When the value is thus set, the difference in amounts of thermal expansion between the adhesives 7 and 8 can be reduced, making it possible to reduce an upward force brought about by the thermal expansion of the adhesive 8 that acts on the optical fiber cores 61.

(Composition of Adhesives)

In the present invention, an adhesive comprising at least the following components (A) and (B) is used for the adhesives 7 and 8 to construct the optical fiber array 1 thus structured.

Component (A): A resin composition having an OH group after curing

Component (B): A filler

Here, component (A) is either a resin composition (component C) having an OH group at least after curing or a resin composition (component D) having an OH group during a component compounding stage, regardless of whether or not the compounded component has an OH group.

The adhesive relating to the present invention may have the following three types of compositions.

Type 1

A resin composition comprising component (C) as component (A)

Type 2

A resin composition comprising component (D) as component (A)

Type 3

A resin composition comprising both components (C) and (D) as component (A)

For example, a bisphenol-type epoxy resin or the like can be used as component (C).

A solid epoxy resin, an oxetane resin, polybutadiene rubber, a polyester resin, or the like can be used as component (D).

Resin beads (component F) or a metal oxide (component E) with a mean grain size in a range of 1 nm to 800 nm, and preferably in a range of 1 nm to 400 nm, can be used as component (B) Component (E) may, for example, be silicon oxide, aluminum oxide, titanium oxide, zinc oxide, or the like.

Next, the inventors conducted the following evaluations to examine heat resistance, humidity resistance, and other such environmental resistance attributes when the optical fiber array is constructed using the adhesive relating to the present invention.

First, the adhesives in Embodiments 1 to 31 and the adhesives in Comparative Examples 1 to 25 shown in Tables 1 through 5 were prepared and then applied to a glass plate that had a length of 25 mm, a width of 20 mm, and a thickness of 1.5 mm. Next, a glass plate with a length of 27.5 mm, a width of 25 mm, and a thickness of 1.5 mm was laminated onto the first glass plate, and then the adhesive was cured to create test specimens. Next, these specimens were left for 20 hours in an atmosphere saturated with water vapor at a temperature of 121° C. and a pressure of 2 atm in a pressure cooker tester, and tests were conducted to confirm their subsequent appearance. In the results of these tests, a ◯ is used in Tables 1 through 5 to denote satisfactory adhesiveness when no peeling occurs in bonded portions, and a X is used in Tables 1 through 5 to denote poor adhesiveness when peeling does occur in the bonded portions.

TABLE 1

| | | | Embodiments | | | | | | | | | |
|---|---|---|---|---|---|---|---|---|---|---|---|---|
| | | | | | | | | | | | | No. |
| Item | | | No. 1 | No. 2 | No. 3 | No. 4 | No. 5 | No. 6 | No. 7 | No. 8 | No. 9 | 10 |
| Component (A) | Component (C) | Bisphenol-type epoxy resin | 74 | 57 | 25 | 61 | 14 | 0 | 0 | 0 | 0 | 0 |
| | | 1,6-Hexanediol diglycidyl ether | 0 | 0 | 0 | 0 | 0 | 0 | 0 | 0 | 0 | 0 |
| | | (3′,4′-Epoxycyclohexane)methyl-3,4- | 0 | 0 | 0 | 0 | 0 | 0 | 0 | 0 | 0 | 57 |
| | | epoxycyclohexane carboxylate | | | | | | | | | | |
| | | ε-Caprolactone-modified 3,4- | 0 | 0 | 0 | 0 | 0 | 0 | 0 | 0 | 57 | 0 |
| | | epoxycyclohexyl methyl-3′,4′- | | | | | | | | | | |
| | | epoxycyclohexane carboxylate | | | | | | | | | | |
| | Component (D) | 3-Ethyl-3-hydroxymethyl | 8 | 25 | 57 | 26 | 30 | 0 | 0 | 0 | 0 | 0 |
| | | oxetane | | | | | | | | | | |
| | | Solid epoxy resin | 0 | 0 | 0 | 0 | 0 | 25 | 25 | 25 | 25 | 25 |
| | | Epoxidized polybutadiene | 0 | 0 | 0 | 0 | 0 | 0 | 0 | 0 | 0 | 0 |

| | | | | | | | | | | | |
|---|---|---|---|---|---|---|---|---|---|---|---|
| Component | Filler | 10 | 10 | 10 | 5 | 50 | 10 | 10 | 10 | 10 | 10 |
| (B, E) | | | | | | | | | | | |
| Other Components | 3-Ethyl-3-phenoxymethyl | 0 | 0 | 0 | 0 | 0 | 0 | 0 | 57 | 0 | 0 |
| | oxetane | | | | | | | | | | |
| | 1,4-Bis[[(3-ethyl-3- | 0 | 0 | 0 | 0 | 0 | 0 | 57 | 0 | 0 | 0 |
| | oxetanyl)methoxy]methyl]benzene | | | | | | | | | | |
| | Di[1-ethyl(3-oxetanyl)]methyl | 0 | 0 | 0 | 0 | 0 | 57 | 0 | 0 | 0 | 0 |
| | ether | | | | | | | | | | |
| | Coupling agent | 4 | 4 | 4 | 4 | 4 | 4 | 4 | 4 | 4 | 4 |
| Curing Agent | Methyltetrahydrophthalic | 0 | 0 | 0 | 0 | 0 | 0 | 0 | 0 | 0 | 0 |
| | anhydride | | | | | | | | | | |
| | Modified aliphatic polyamine | 0 | 0 | 0 | 0 | 0 | 0 | 0 | 0 | 0 | 0 |
| | 2-Ethyl-4-methyl imidazole | 0 | 0 | 0 | 0 | 0 | 0 | 0 | 0 | 0 | 0 |
| | Tetrakis(pentafluorophenyl)borate-[methyl- | 4 | 4 | 4 | 4 | 2 | 4 | 4 | 4 | 4 | 4 |
| | 4-phenyl(methyl-1-ethyl)-4-phenyl]- | | | | | | | | | | |
| | iodonium | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |
| Evaluation Results (Adhesiveness) | ◯ | ◯ | ◯ | ◯ | ◯ | ◯ | ◯ | ◯ | ◯ | ◯ |

TABLE 2

| | | | Embodiments | | | | | | | | | |
|---|---|---|---|---|---|---|---|---|---|---|---|---|
| | | | No. | No. | | No. | No. | No. | | No. | | No. |
| Item | | | 11 | 12 | No. 13 | 14 | 15 | 16 | No. 17 | 18 | No. 19 | 20 |
| Component (A) | Component (C) | Bisphenol-type epoxy resin | 0 | 0 | 0 | 0 | 0 | 0 | 0 | 74 | 57 | 25 |
| | | 1,6-Hexanediol diglycidyl ether | 57 | 0 | 0 | 0 | 0 | 0 | 57 | 8 | 25 | 57 |
| | | (3′,4′-Epoxycyclohexane)methyl-3,4- | 0 | 0 | 0 | 0 | 0 | 57 | 0 | 0 | 0 | 0 |
| | | epoxycyclohexane carboxylate | | | | | | | | | | |
| | | ε-Caprolactone-modified 3,4- | 0 | 0 | 0 | 0 | 57 | 0 | 0 | 0 | 0 | 0 |
| | | epoxycyclohexyl methyl-3′,4′- | | | | | | | | | | |
| | | epoxycyclohexane carboxylate | | | | | | | | | | |
| | Component (D) | 3-Ethyl-3-hydroxymethyl oxetane | 0 | 0 | 0 | 0 | 0 | 0 | 0 | 0 | 0 | 0 |
| | | Solid epoxy resin | 25 | 0 | 0 | 0 | 0 | 0 | 0 | 0 | 0 | 0 |
| | | Epoxidized polybutadiene | 0 | 25 | 25 | 25 | 25 | 25 | 25 | 0 | 0 | 0 |

| | | | | | | | | | | | |
|---|---|---|---|---|---|---|---|---|---|---|---|
| Component | Filler | 10 | 10 | 10 | 10 | 10 | 10 | 10 | 10 | 10 | 10 |
| (B, E) | | | | | | | | | | | |
| Other Components | 3-Ethyl-3-phenoxymethyl oxetane | 0 | 0 | 0 | 57 | 0 | 0 | 0 | 0 | 0 | 0 |
| | 1,4-Bis[[(3-ethyl-3- | 0 | 0 | 57 | 0 | 0 | 0 | 0 | 0 | 0 | 0 |
| | oxetanyl)methoxy]methyl]benzene | | | | | | | | | | |
| | Di[1-ethyl(3-oxetanyl)]methyl | 0 | 57 | 0 | 0 | 0 | 0 | 0 | 0 | 0 | 0 |
| | ether | | | | | | | | | | |
| | Coupling agent | 4 | 4 | 4 | 4 | 4 | 4 | 4 | 4 | 4 | 4 |
| Curing Agent | Methyltetrahydrophthalic anhydride | 0 | 0 | 0 | 0 | 0 | 0 | 0 | 0 | 0 | 0 |
| | Modified aliphatic polyamine | 0 | 0 | 0 | 0 | 0 | 0 | 0 | 0 | 0 | 0 |
| | 2-Ethyl-4-methyl imidazole | 0 | 0 | 0 | 0 | 0 | 0 | 0 | 4 | 4 | 4 |
| | Tetrakis(pentafluorophenyl)borate- | 4 | 4 | 4 | 4 | 4 | 4 | 4 | 0 | 0 | 0 |
| | [methyl-4-phenyl(methyl-1-ethyl)-4- | | | | | | | | | | |
| | phenyl]-iodonium | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |
| Evaluation Results (Adhesiveness) | ◯ | ◯ | ◯ | ◯ | ◯ | ◯ | ◯ | ◯ | ◯ | ◯ |

TABLE 3

| | | | Embodiments | | | | | | | | | | |
|---|---|---|---|---|---|---|---|---|---|---|---|---|---|
| | | | No. | No. | No. | No. | No. | | No. | No. | No. | No. | No. |
| Item | | | 21 | 22 | 23 | 24 | 25 | No. 26 | 27 | 28 | 29 | 30 | 31 |
| Component (A) | Component (C) | Bisphenol-type epoxy resin | 61 | 14 | 57 | 41 | 74 | 57 | 25 | 61 | 14 | 57 | 41 |
| | | 1,6-Hexanediol diglycidyl ether | 26 | 30 | 0 | 0 | 8 | 25 | 57 | 26 | 30 | 0 | 0 |
| | | (3′,4′-Epoxycyclohexane)methyl- | 0 | 0 | 25 | 0 | 0 | 0 | 0 | 0 | 0 | 25 | 0 |
| | | 3,4-epoxycyclohexane carboxylate | | | | | | | | | | | |
| | | ε-Caprolactone-modified 3,4- | 0 | 0 | 0 | 0 | 0 | 0 | 0 | 0 | 0 | 0 | 0 |
| | | epoxycyclohexyl methyl-3′,4′- | | | | | | | | | | | |
| | | epoxycyclohexane carboxylate | | | | | | | | | | | |
| | Component (D) | 3-Ethyl-3-hydroxymethyl | 0 | 0 | 0 | 0 | 0 | 0 | 0 | 0 | 0 | 0 | 0 |
| | | oxetane | | | | | | | | | | | |
| | | Solid epoxy resin | 0 | 0 | 0 | 0 | 0 | 0 | 0 | 0 | 0 | 0 | 0 |
| | | Epoxidized polybutadiene | 0 | 0 | 0 | 0 | 0 | 0 | 0 | 0 | 0 | 0 | 0 |

| | | | | | | | | | | | | |
|---|---|---|---|---|---|---|---|---|---|---|---|---|
| Component | Filler | 5 | 50 | 10 | 10 | 10 | 10 | 10 | 5 | 50 | 10 | 10 |
| (B, E) | | | | | | | | | | | | |
| Other Components | 3-Ethyl-3-phenoxymethyl | 0 | 0 | 0 | 0 | 0 | 0 | 0 | 0 | 0 | 0 | 0 |
| | oxetane | | | | | | | | | | | |
| | 1,4-Bis[[(3-ethyl-3- | 0 | 0 | 0 | 0 | 0 | 0 | 0 | 0 | 0 | 0 | 0 |
| | oxetanyl)methoxy]methyl]benzene | | | | | | | | | | | |
| | Di[1-ethyl(3-oxetanyl)]methyl | 0 | 0 | 0 | 0 | 0 | 0 | 0 | 0 | 0 | 0 | 0 |
| | ether | | | | | | | | | | | |
| | Coupling agent | 4 | 4 | 4 | 4 | 4 | 4 | 4 | 4 | 4 | 4 | 4 |
| Curing Agent | Methyltetrahydrophthalic | 0 | 0 | 41 | 0 | 0 | 0 | 0 | 0 | 0 | 0 | 41 |
| | anhydride | | | | | | | | | | | |
| | Modified aliphatic polyamine | 0 | 0 | 0 | 0 | 4 | 4 | 4 | 4 | 2 | 4 | 4 |
| | 2-Ethyl-4-methyl imidazole | 4 | 2 | 4 | 4 | 0 | 0 | 0 | 0 | 0 | 0 | 0 |
| | Tetrakis(pentafluorophenyl)borate- | 0 | 0 | 0 | 0 | 0 | 0 | 0 | 0 | 0 | 0 | 0 |
| | [methyl-4-phenyl(methyl-1-ethyl)- | | | | | | | | | | | |
| | 4-phenyl]-iodonium | | | | | | | | | | | |

| | | | | | | | | | | | |
|---|---|---|---|---|---|---|---|---|---|---|---|
| Total | 100 | 100 | 100 | 100 | 100 | 100 | 100 | 100 | 100 | 100 | 100 |
| Evaluation Results (Adhesiveness) | ◯ | ◯ | ◯ | ◯ | ◯ | ◯ | ◯ | ◯ | ◯ | ◯ | ◯ |

TABLE 4

| | | | Comparative Examples | | | | | | | | | |
|---|---|---|---|---|---|---|---|---|---|---|---|---|
| | | | | | | | | | | | | No. |
| Item | | | No. 1 | No. 2 | No. 3 | No. 4 | No. 5 | No. 6 | No. 7 | No. 8 | No. 9 | 10 |
| Component | Component | Bisphenol-type epoxy resin | 83 | 64 | 28 | 0 | 0 | 0 | 0 | 0 | 0 | 83 |
| (A) | (C) | 1,6-Hexanediol diglycidyl ether | 0 | 0 | 0 | 0 | 0 | 0 | 0 | 0 | 0 | 9 |
| | | (3′,4′-Epoxycyclohexane)methyl-3,4- | 0 | 0 | 0 | 0 | 0 | 0 | 0 | 0 | 0 | 0 |
| | | epoxycyclohexane carboxylate | | | | | | | | | | |
| | | ε-Caprolactone-modified 3,4- | 0 | 0 | 0 | 0 | 0 | 0 | 0 | 0 | 0 | 0 |
| | | epoxycyclohexyl methyl-3′,4′- | | | | | | | | | | |
| | | epoxycyclohexane carboxylate | | | | | | | | | | |
| | Component | 3-Ethyl-3-hydroxymethyl oxetane | 9 | 28 | 64 | 0 | 0 | 0 | 0 | 0 | 0 | 0 |
| | (D) | Solid epoxy resin | 0 | 0 | 0 | 28 | 28 | 28 | 0 | 0 | 0 | 0 |
| | | Epoxidized polybutadiene | 0 | 0 | 0 | 0 | 0 | 0 | 28 | 28 | 28 | 0 |

| | | | | | | | | | | | |
|---|---|---|---|---|---|---|---|---|---|---|---|
| Component | Filler | 0 | 0 | 0 | 0 | 0 | 0 | 0 | 0 | 0 | 0 |
| (B, E) | | | | | | | | | | | |
| Other Components | 3-Ethyl-3-phenoxymethyl oxetane | 0 | 0 | 0 | 0 | 0 | 64 | 0 | 0 | 64 | 0 |
| | 1,4-Bis{[(3-ethyl-3- | 0 | 0 | 0 | 0 | 64 | 0 | 0 | 64 | 0 | 0 |
| | oxetanyl)methoxy]methyl}benzene | | | | | | | | | | |
| | Di[1-ethyl(3-oxetanyl)]methyl | 0 | 0 | 0 | 64 | 0 | 0 | 64 | 0 | 0 | 0 |
| | ether | | | | | | | | | | |
| | Coupling agent | 4 | 4 | 4 | 4 | 4 | 4 | 4 | 4 | 4 | 4 |
| Curing Agent | Methyltetrahydrophthalic | 0 | 0 | 0 | 0 | 0 | 0 | 0 | 0 | 0 | 0 |
| | anhydride | | | | | | | | | | |
| | Modified aliphatic polyamine | 0 | 0 | 0 | 0 | 0 | 0 | 0 | 0 | 0 | 0 |
| | 2-Ethyl-4-methyl imidazole | 0 | 0 | 0 | 0 | 0 | 0 | 0 | 0 | 0 | 4 |
| | Tetrakis(pentafluorophenyl)borate- | 4 | 4 | 4 | 4 | 4 | 4 | 4 | 4 | 4 | 0 |
| | [methyl-4-phenyl(methyl-1-ethyl)-4- | | | | | | | | | | |
| | phenyl]-iodonium | | | | | | | | | | |

| | | | | | | | | | | |
|---|---|---|---|---|---|---|---|---|---|---|
| Total | 100 | 100 | 100 | 100 | 100 | 100 | 100 | 100 | 100 | 100 |
| Evaluation Results (Adhesiveness) | X | X | X | X | X | X | X | X | X | X |

TABLE 5

| | | | Comparative Examples | | | | | | | | | | |
|---|---|---|---|---|---|---|---|---|---|---|---|---|---|
| | | | No. | No. | No. | No. | No. | No. | No. | No. | No. | No. | No. |
| Item | | | 11 | 12 | 13 | 14 | 15 | 16 | 17 | 18 | 19 | 20 | 21 |
| Component (A) | Component (C) | Bisphenol-type epoxy resin | 64 | 28 | 64 | 46 | 80 | 0 | 0 | 0 | 0 | 0 | 0 |
| | | 1,6-Hexanediol diglycidyl ether | 28 | 64 | 0 | 0 | 0 | 0 | 0 | 0 | 0 | 0 | 0 |
| | | (3′,4′-Epoxycyclohexane)methyl-3,4- | 0 | 0 | 28 | 0 | 0 | 0 | 0 | 0 | 0 | 0 | 0 |
| | | epoxycyclohexane carboxylate | | | | | | | | | | | |
| | | ε-Caprolactone-modified 3,4- | 0 | 0 | 0 | 0 | 0 | 0 | 0 | 0 | 0 | 0 | 0 |
| | | epoxycyclohexyl methyl-3′,4′- | | | | | | | | | | | |
| | | epoxycyclohexane carboxylate | | | | | | | | | | | |
| | Component (D) | 3-Ethyl-3-hydroxymethyl oxetane | 0 | 0 | 0 | 0 | 2 | 0 | 0 | 0 | 0 | 0 | 0 |
| | | Solid epoxy resin | 0 | 0 | 0 | 0 | 0 | 2 | 2 | 2 | 0 | 0 | 0 |
| | | Epoxidized polybutadiene | 0 | 0 | 0 | 0 | 0 | 0 | 0 | 0 | 2 | 2 | 2 |

| | | | | | | | | | | | | |
|---|---|---|---|---|---|---|---|---|---|---|---|---|
| Component | Filler | 0 | 0 | 0 | 0 | 10 | 10 | 10 | 10 | 10 | 10 | 10 |
| (B, E) | | | | | | | | | | | | |
| Other Components | 3-Ethyl-3-phenoxymethyl oxetane | 0 | 0 | 0 | 0 | 0 | 0 | 0 | 80 | 0 | 0 | 80 |
| | 1,4-Bis{[(3-ethyl-3- | 0 | 0 | 0 | 0 | 0 | 0 | 80 | 0 | 0 | 80 | 0 |
| | oxetanyl)methoxy]methyl}benzene | | | | | | | | | | | |
| | Di[1-ethyl(3-oxetanyl)]methyl ether | 0 | 0 | 0 | 0 | 0 | 80 | 0 | 0 | 80 | 0 | 0 |
| | Coupling agent | 4 | 4 | 4 | 4 | 4 | 4 | 4 | 4 | 4 | 4 | 4 |
| Curing Agent | Methyltetrahydrophthalic anhydride | 0 | 0 | 0 | 46 | 0 | 0 | 0 | 0 | 0 | 0 | 0 |
| | Modified aliphatic polyamine | 0 | 0 | 0 | 0 | 0 | 0 | 0 | 0 | 0 | 0 | 0 |
| | 2-Ethyl-4-methyl imidazole | 4 | 4 | 4 | 4 | 0 | 0 | 0 | 0 | 0 | 0 | 0 |
| | Tetrakis(pentafluorophenyl)borate- | 0 | 0 | 0 | 0 | 4 | 4 | 4 | 4 | 4 | 4 | 4 |
| | [methyl-4-phenyl(methyl-1-ethyl)-4- | | | | | | | | | | | |
| | phenyl]-iodonium | | | | | | | | | | | |

| | | | | | | | | | | | |
|---|---|---|---|---|---|---|---|---|---|---|---|
| Total | 100 | 100 | 100 | 100 | 100 | 100 | 100 | 100 | 100 | 100 | 100 |
| Evaluation Results (Adhesiveness) | X | X | X | X | X | X | X | X | X | X | X |

The correspondence between each material used in the adhesives shown in Tables 1 through 5 and the components (A) through (E) is as follows.

Component (C) as Component (A)

(Component 1): Bisphenol-type epoxy resin
(Component 2): 1,6-Hexanediol diglycidyl ether
(Component 3): (31,4′-Epoxycyclohexane)methyl-3,4-epoxycyclohexane carboxylate
(Component 4): ε-Caprolactone-modified 3,4-epoxycyclohexylmethyl-3′,4′-epoxycyclohexane carboxylate
   Component (D) as Component (A)
(Component 5): 3-Ethyl-3-hydroxymethyl oxetane
(Component 6): Solid epoxy resin
(Component 7): Epoxidized polybutadiene
   Component (E) as Component (B)
(Component 8): Silicon dioxide (SiO₂)
   Other Components
(Component 9): 3-Ethyl-3-phenoxymethyl oxetane
(Component 10): 1,4-Bis{[(3-ethyl-3-oxetanyl)methoxy]methyl}benzene
(Component 11): Di[1-ethyl(3-oxetanyl)]methyl ether
   Coupling Agent
   Curing Agent
(Component 12): Methyltetrahydrophthalic anhydride
(Component 13): Modified aliphatic polyamine
(Component 14): 2-Ethyl-4-methyl imidazole
(Component 15): Tetrakis(pentafluorophenyl)borate-[methyl-4-phenyl(methyl-1-ethyl)-4-phenyl]-iodonium

Consequently, of the adhesives relating to the embodiments of the present invention shown in Tables 1 through 3, those in Embodiments 18 through 31 belong to Type 1. Those in Embodiments 6 through 8 and Embodiments 12 through 14 belong to Type 2. Also, those in Embodiments 1 through 5, Embodiments 9 through 11, and Embodiments 15 through 17 belong to Type 3.

By contrast, those in Comparative Examples 1 through 14 are compositions without a compounded filler. Comparative Examples 16 through 21 are comparative examples corresponding to Type 2, and Comparative Example 15 is a comparative example corresponding to Type 3.

As a result of evaluating environmental resistance achieved with the use of such adhesives and conducted based on the presence or absence of peeling in a pressure cooker test, it was found that there was no peeling or other problems in any of the Embodiments 1 through 31 relating to the present invention as shown in Tables 1 through 3, and that it was possible to obtain a high environmental resistance performance.

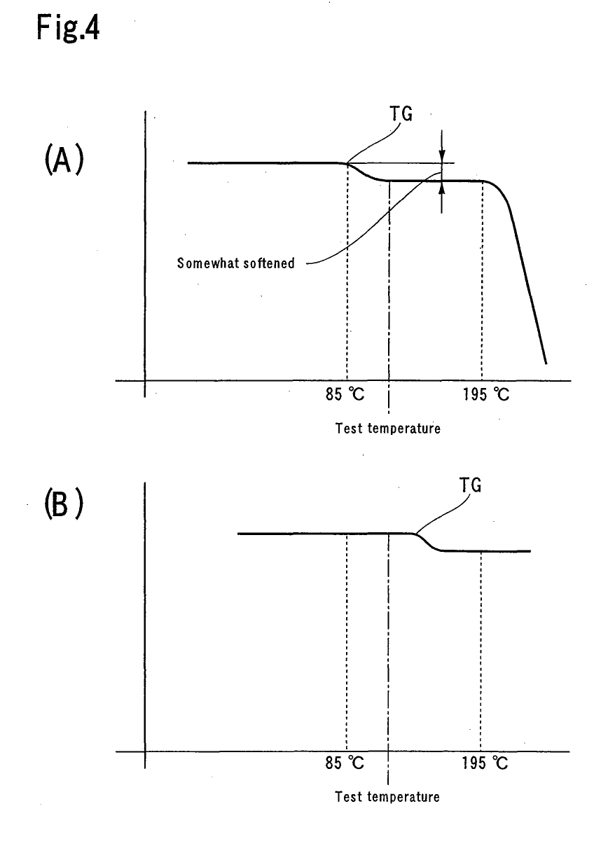

The reason for this is that with the adhesives in Embodiments 1 through 31, the glass transition temperature Tg is somewhat lower than the ambient test temperature, and elasticity is somewhat higher, as shown in FIG. 4(A). Therefore, large internal stress does not occur in the adhesive even under conditions of high temperature and high humidity. Consequently, no peeling occurs as a result of moisture penetration since gaps cannot form between the pressure plate and the adhesive.

By contrast, in Comparative Examples 1 through 14, peeling occurs due to the absence of the compounded filler. Comparative Examples 16 through 21 and Comparative Example 15 are comparative examples corresponding to Type 2 and Type 3, respectively, but peeling occurs due to a small compounding amount of component (D).

Various studies conducted by the inventors concerning matters other than the compositions shown in Tables 1 through 5 indicate that when a Type 2 adhesive comprising component (D) and a Type 3 adhesive comprising components (C) and (D) are used as component (A), the compounding amount of component (D) must be 8% by weight or greater of the entire adhesive, and is preferably 25% by weight or greater.

Resin beads (component F) may be used as filler (B) in addition to using a metal oxide as component (E). When any type of filler is used, the compounding amount of the filler is preferably 5% by weight to 50% by weight of the entire adhesive; the effect decreases when the compounding amount of the filler is less than 5% by weight of the entire adhesive, and viscosity is too high and handling is impaired when the amount exceeds 50% by weight.

(Other Aspects)

To prevent peeling between the V-groove substrate and the pressure plate in the optical fiber array, it is preferable to increase bonding strength between them. In order to increase the bonding strength, at least one surface from among the front surface of the V-groove substrate and the surface of the pressure plate bonded to the V-groove substrate should have a matte finish. The matte finish may, for example, be obtained by grinding, shot peening, or shot blasting. When the surface thus bonded is given the matte finish, wettability of the adhesive is improved and an anchoring effect due to mechanical bonding between the cured adhesive and the surface with the matte finish can be expected. As a result, the bonding strength between the V-groove substrate and the pressure plate can be increased, and an optical fiber array wherein these components are resistant to peeling can be formed.

In addition to the surface with the matte finish, at least one surface from among the surface of the V-groove substrate, the surface of the pressure plate coupled with the V-groove substrate, and the external peripheral surfaces of the optical fiber cores may be provided with concavities and convexities by metal coating or plasma discharge processes. This will cause the anions in the bonded surface to become charged and a plurality of minute dimples to be formed, therefore wettability of the adhesive can be improved and bonding strength enhanced.

### INDUSTRIAL APPLICABILITY

As described above, in the present invention, an adhesive that comprises a resin composition (component A) that has an OH group after curing and a filler (component B) is used to fixedly bond a V-groove substrate, optical fiber cores, and a pressure plate, so a glass transition temperature is somewhat lower than the ambient test temperature, and elasticity is somewhat higher. Therefore, large internal stress does not occur in the adhesive even under conditions of high temperature and high humidity. Consequently, no peeling occurs as a result of moisture penetration since gaps cannot form between the pressure plate and the adhesive.

1-11. (canceled)

12. An optical fiber array having a V-groove substrate formed in its surface with V-grooves for arranging optical fibers, optical fiber cores fixedly bonded in the V-grooves of the V-groove substrate, and a pressure plate fixedly bonded to surfaces of the optical fiber cores, wherein (i) an adhesive is used to fixedly bond the V-groove substrate, the optical fiber cores, and the pressure plate, and (ii) the adhesive comprises:
(A) an epoxy resin,
(B) 3-Ethyl-3-hydroxymethyl oxetane, and
(C) a filler made of metal oxide particles and being 20% by weight to 40% by weight of the adhesive.

13. The optical fiber array according to claim 12, wherein the metal oxide is a mixture of two or more materials selected from silicon oxide, aluminum oxide, titanium oxide, and zinc oxide.

14. The optical fiber array according to claim 12, wherein the 3-Ethyl-3-hydroxymethyl oxetane is at least 25% by weight of the adhesive.

15. The optical fiber array according to claim 13, wherein the 3-Ethyl-3-hydroxymethyl oxetane is at least 25% by weight of the adhesive.

16. The optical fiber array according to claim 12, wherein the metal oxide filler has a mean particle size of 50 nm to 800 nm.

17. The optical fiber array according to claim 13, wherein the metal oxide filler has a mean particle size of 50 nm to 800 nm.

18. The optical fiber array according to claim 14, wherein the metal oxide filler has a mean particle size of 50 nm to 800 nm.

19. The optical fiber array according to claim 15, wherein the metal oxide filler has a mean particle size of 50 nm to 800 nm.
